(19) United States
(12) Patent Application Publication
(10) Pub. No.: US 2018/0031091 A1
(43) Pub. Date: Feb. 1, 2018

(54) MINIATURE LINEAR ACTUATOR

(71) Applicant: TIMOTION TECHNOLOGY CO., LTD., New Taipei City (TW)

(72) Inventor: Chou-Hsin WU, New Taipei City (TW)

(21) Appl. No.: 15/256,558

(22) Filed: Sep. 3, 2016

(30) Foreign Application Priority Data
Aug. 1, 2016 (TW) 105211611

(51) Int. Cl. F16H 25/20

(52) U.S. Cl. CPC F16H 25/20; F16H 2025/209; F16H 2025/2084; F16H 2025/2031; F16H 2025/204

(57) ABSTRACT

A linear actuator includes a shell (10), an actuator mechanism (20), a telescopic tube (30) and at least one limit switch (40). An inner wall of the shell (10) has a guiding rail (11) formed thereon. The actuator mechanism (20) is disposed in the shell (10) and includes a motor (21) and a lead screw (22) driven by the motor (21). The telescopic tube (30) includes a nut (31) screwed with the lead screw (22) and an inner tube (32) integrally formed with the nut (31). The nut (31) has switching structures (311) and guiding slots (312) corresponding to the guiding rails (11). The limit switch (40) is fixed in the shell (10), and the limit switch (40) is capable of operating by a press of the switching structure (311). Therefore, the assembling of the linear actuator will be simplified for reducing sizes of components and occupied installation space.

### BACKGROUND OF THE INVENTION

### Field of the Invention

The present invention generally relates to linear actuators and, more particular to, miniature linear actuators.

### Description of Prior Art

Linear actuators are widely used in devices of everyday life such as massage chairs, electric chairs, electric hospital beds, treadmills, folding beds, furniture and lifting mechanism that usually utilize linear actuators for position adjustment. A conventional linear actuator mainly drives a lead screw rotating by driving components such as motors, worms and worm gears etc. In the meanwhile, the lead screw drives a telescopic tube screwed thereon to perform a linearly extending or retracting motion relative to an outer tube sleeved on the telescopic tube.

Telescopic tubes of traditional linear actuators are composed of nuts and inner tubes which are screwed with each other. However, the nuts need forming screws and that will increase the forming time of the nuts. In addition, the inner tubes also need forming screws correspondingly for screwing with the nuts. As a result, it has problems of high cost and time consuming. On the other hand, designs of linear actuators must be simplified and sizes have to be miniaturized in order to reduce space and cost in small electronic devices.

In view of the above drawbacks, the Inventor proposes the present invention based on his expert knowledge and elaborate researches in order to solve the problems of prior art.

### SUMMARY OF THE INVENTION

Accordingly, an object of the present invention is to provide a miniature linear actuator for simplifying manufacturing process, and the assembling of the linear actuator will be simplified for reducing sizes of components and installation space as to accomplish a miniature linear actuator.

The present invention provides a miniature linear actuator including a shell, an actuator mechanism, a telescopic tube and at least one limit switch. The shell has a guiding rail disposed on an inner wall. The actuator mechanism is disposed in the shell and includes a motor and a lead screw driven by the motor. The telescopic tube includes a nut screwed with the lead screw and an inner tube integrally formed with the nut. The nut has switching structures and guiding slots corresponding to the guiding rails. The limit switch is fixed in the shell, and the limit switch is capable of operating by a press of the switching structure.

Accordingly, another object of the present invention is to provide a miniature linear actuator that a bearing is disposed at the shaft of the motor, in which the shell has formed a supporting structure to stop the bearing from moving in order to reduce a friction inside the motor; thus the service life of the motor will be increased.

Accordingly, a further object of the present invention is to provide a miniature linear actuator that the worm gear, the lead screw and the fixing bearing are combined into a single unit for saving space effectively and reducing cost.

Accordingly, an object of the present invention is to provide a miniature linear actuator that the nut has switching structures and guiding slots for changing setup angles as to increase convenience of assembly.

Accordingly, another object of the present invention is to provide a miniature linear actuator that the shell has formed a plurality of pillars on an inner wall so that the limit switch can be selectively positioned thereon in order to reduce cost and number of components.

Accordingly, still another object of the present invention is to provide a miniature linear actuator that the rear stand is composed of a plurality of clamping pieces, and the setup angles can be adjusted by changing the orientation of the assembling as to increase convenience of assembly.

Accordingly, still a further object of the present invention is to provide a miniature linear actuator that the bearing is tightly fixed on the lead screw by the screw of the rear stand, in which the length of the screw is extended to the location of the worm gear for supporting the worn gear.

Comparing to the prior art, the telescopic tube of the miniature linear actuator of the present invention is composed of the nut and the inner tube which are integrally formed for simplifying the structures of the telescopic and in order to reduce cost and the number of components. In addition, the nut of the present invention has switching structures and guiding slots for increasing convenience of assembly. Moreover, the worm, the lead screw and the fixing bearing are configured in a single unit for saving space effectively, and thus a purpose of miniaturization of the linear actuator will be achieved.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective explosion schematic view of a miniature linear actuator of the present invention;

FIG. 2 is a perspective explosion schematic view of a telescopic tube and a lead screw of the present invention;

FIG. 3 is a cross sectional view of a lead screw of the present invention;

FIG. 4 is a perspective schematic view of a miniature linear actuator of the present invention;

FIG. 5 is a partial enlarged schematic view in a shell of the present invention;

FIG. 6 is a partial cross sectional view along the line 6-6 of the FIG. 4;

FIG. 7 is a partial cross sectional view along the line 7-7 of the FIG. 4;

FIG. 8 is one setup angle of the rear stand after assembling; and

FIG. 9 is another setup angle of the rear stand after assembling.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

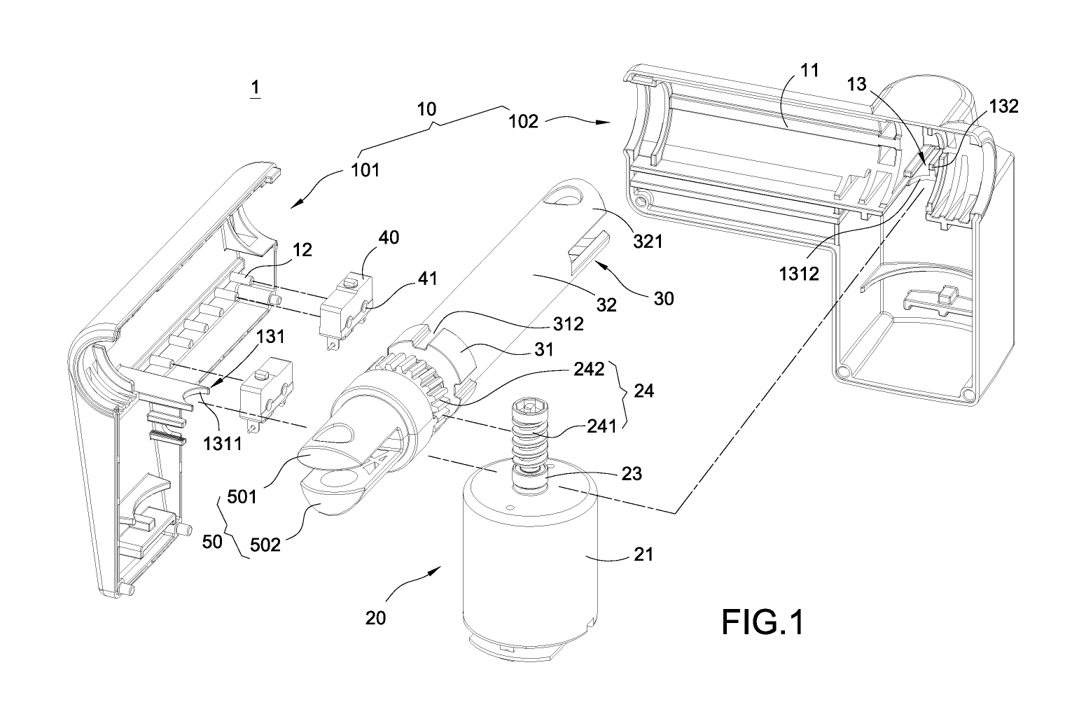

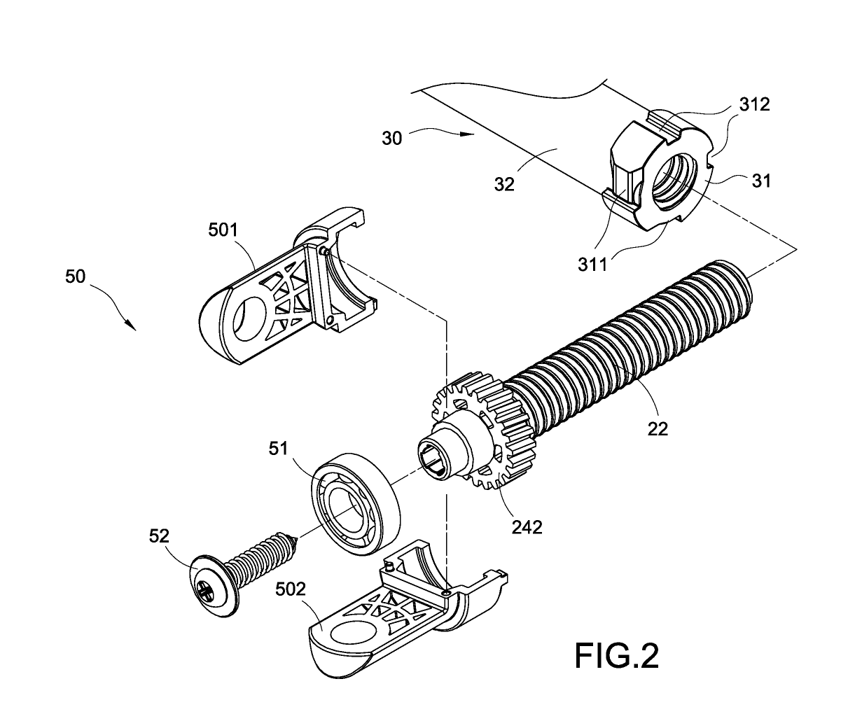

Please refer to FIG. 1 to FIG. 4, they depict a perspective explosion schematic view of a miniature linear actuator, a perspective explosion schematic view of a telescopic tube and a lead screw, a cross sectional view of the lead screw, and a perspective schematic view of a miniature linear actuator of the present invention. A miniature linear actuator 1 of the present invention includes a shell 10, an actuator mechanism 20, a telescopic tube 30 and at least one limit switch 40. The actuator mechanism 20 and the limit switch 40 are disposed in the shell 10. One end of the telescopic tube 30 is combined in the shell, and the other end is retractable and extended out the shell 10. Besides, the limit switch 40 is used to control a retracted position of the telescopic tube 30.

The shell 10 includes a first seat 101 and a second seat 102. The first seat 101 and the second seat 102 are coupled to each other for forming a hollow shell 10, and the shell 10 has a guiding rail 11 disposed on an inner wall.

The actuator mechanism 20 is disposed in the shell 10. The actuator mechanism 20 includes a motor 21 and a lead screw 22 driven by the motor 22. Moreover, the telescopic tube 30 includes a nut 31 screwed with the lead screw 22 and an inner tube 32 integrally formed with the nut 31, wherein the nut 31 and the inner tube 32 are provided in a single unit for simplifying structures in order to reduce cost and number of components.

The nut 31 has at least one switching structure 311 and at least one guiding slot 312 corresponding to the guiding rail 11. Preferably, the switching structure 311 and the guiding slot 312 are formed on a peripheral surface of the nut 31. In addition, the telescopic tube 3 is capable of moving along the guiding rail 11 relative to the shell 10 through the deposition of the guiding slot 312.

It is worth of notice that the nut 31 of the present invention has a plurality of switching structures 311 and a plurality of guiding rails 312. As a result of angle incompatibility problems that might be occurred in screwing during assembly, a plurality of the switching structures 311 and the guiding rails 312 are provided as to facilitate the assembly when adjusting angles of installation and to increase convenience of assembly.

Moreover, the at least one limit switch 40 is fixed in the shell 10, and the limit switch 40 is capable of operating by the pressing of the switching structure 311. That is, the switching structure 311 is used to press the limit switch 40 for controlling the operation of the actuator mechanism 20.

In an embodiment of the present invention, the limit switch 40 has at least one fixing hole 41. On the other hand, the shell 10 has formed a plurality of pillars 12 corresponding to the fixing hole 41 on an inner wall, and then the limit switch 40 can be selectively positioned at one of the pillars 12.

More specifically, the actuator mechanism 20 further includes a bearing 23 and a worm gear group 24. The motor 21 has a shaft 211, and the shell 10 has formed a supporting structure 13 corresponding to the shaft 211 on an inner wall, wherein the bearing 23 is sleeved on the shaft 211 and stopped by the supporting structure 13 from moving. The fixing of the bearing 23 will be described more detail later.

Furthermore, the worm gear group 24 includes a worm 241 and a worm gear 242 which are engaged with each other. The worm 241 is axially sleeved on the shaft 211 of the motor 21; the worm gear 242 is located at an end of the lead screw 22, and the worm 241 is driven by the motor 21 and rotated with the shaft 211 together.

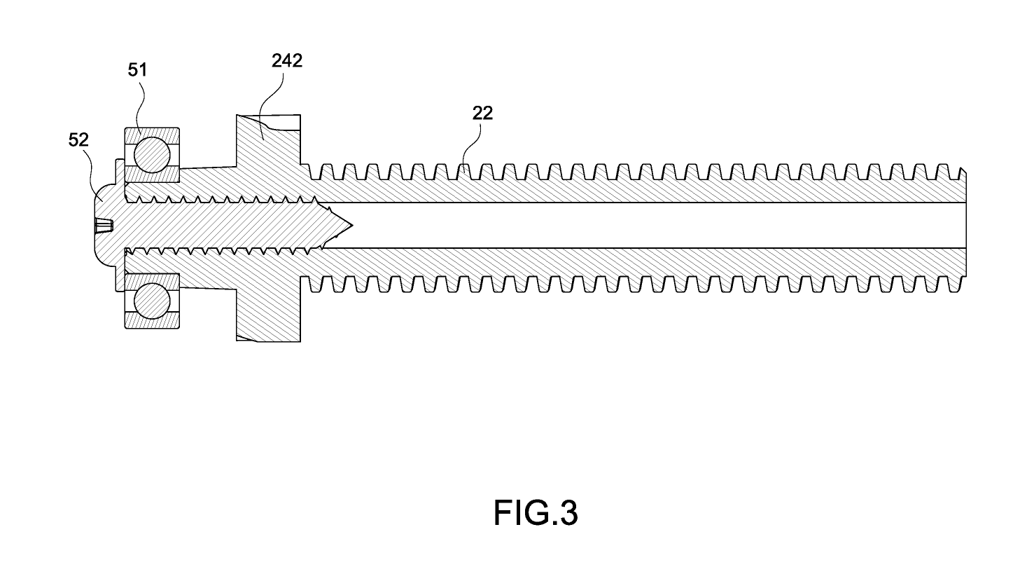

Also, the miniature linear actuator 1 further includes a rear stand 50 and a fixing bearing 51. The rear stand 50 covers the fixing bearing 51, and the fixing bearing 51 is fixed on an end of the lead screw 22 through a screw 52. Please refer to FIG. 3, in the present embodiment, the screw 52 is inserted in the lead screw 22 and extended to the location of the worm gear 242.

It is worth of notice that the rear stand 50 includes a first clamping piece 501 and a second clamping piece 502. In addition, the first clamping piece 501 and the second clamping piece 502 are coupled to form a trough 500, and the angle of the trough 500 can be changed by adjusting an orientation of a combination of the first clamping piece 501 and the second clamping piece 502.

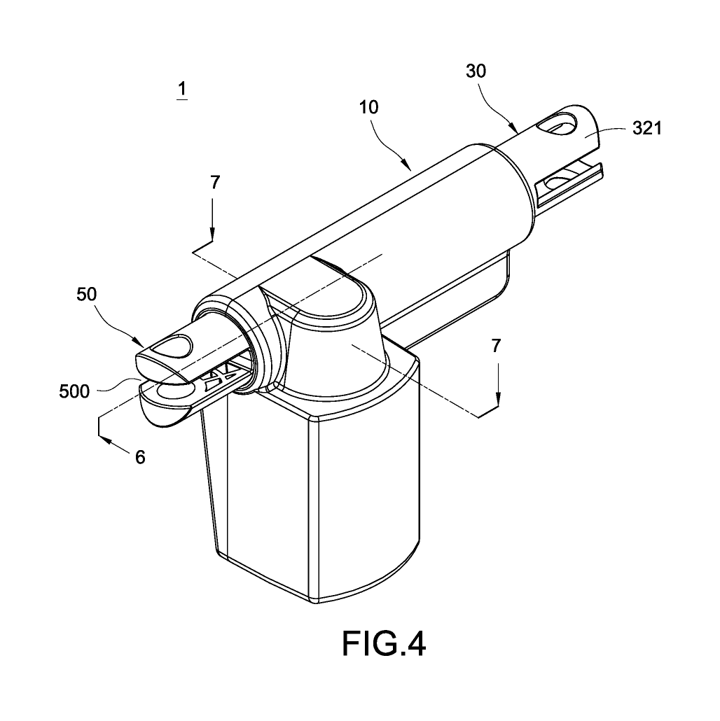

As shown in FIG. 4, the miniature linear actuator 1 of the present invention further includes a front stand 321 configured in a fork shape, and the front stand 321 is integrally formed with the inner tube 32 at an outer end of the inner tube 32. The front stand 321 is provided for connecting and driving an object.

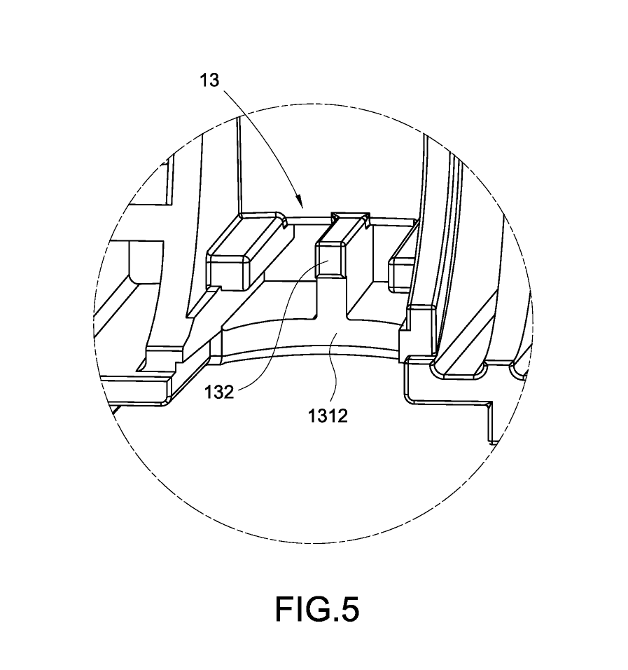

With further referring to FIG. 5 to FIG. 7, they depict a partial enlarged schematic view inside the shell, a partial cross sectional view along the line 6-6 of the FIG. 4, and a partial cross sectional view along the line 7-7 of the FIG. 4 of the present invention. In the present embodiment, as shown in FIG. 5 and FIG. 7, the supporting structure 13 includes an annular seat 131 and a blocking wall 132 protruding at an upper of the annular seat 131. Preferably, the annular seat 131 is composed of a plurality of half-annular seats 1311, 1312. The half-annular seats 1311, 1312 are disposed at the first seat 101 and the second seat 102 separately and are configured to form the annular seat 131 through a combination.

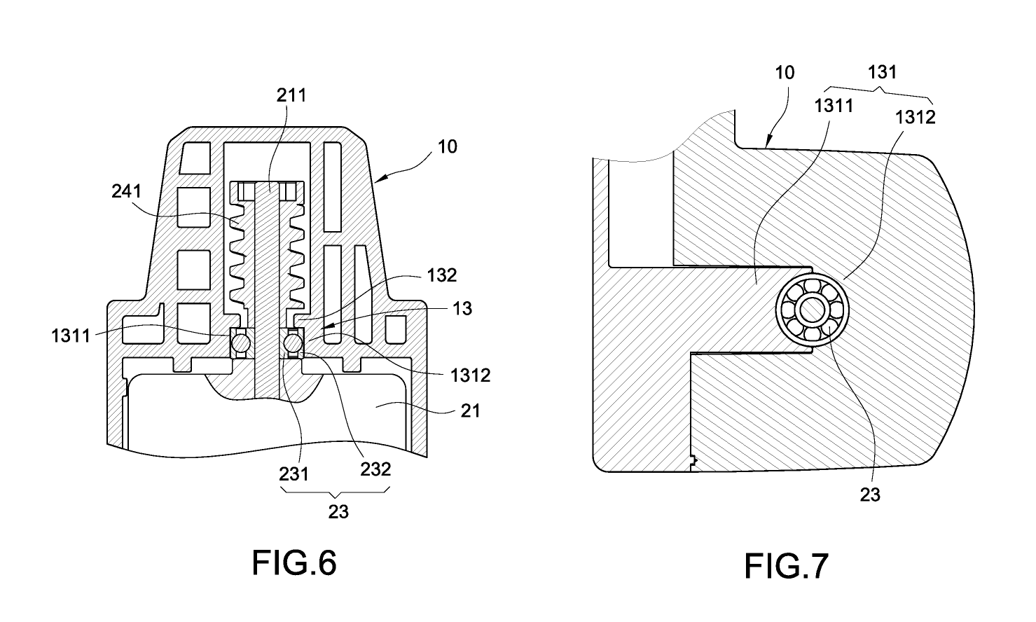

Furthermore, please refer to FIG. 6, the bearing 23 includes an inner bearing annular 231 and an outer bearing annular 232. The inner bearing annular 231 abuts against the shaft 211 of the motor 21; one side of the outer bearing annular 232 abuts against the annular seat 131, and a perpendicular other side abuts against the blocking wall 132.

Thereby, when the worm 241 receives an upward force transmitted from the worm gear 242, the shaft 211 of the motor 21 will also receive an upward force; besides, the bearing 23 will move upward in turn, and the outer bearing annular 232 will contact with the blocking wall 132. At this time, an internal friction of the motor 21 can be avoided by the deposition of the bearing 23. Similarly, when the worm 241 receives a rightward force transmitted from the worm gear 242, the force of the worm 241 will be transmitted to the bearing 23 due to the motor 21 is fixed. Therefore, the force of the worm 241 will be transmitted to the bearing 23, and the bearing 23 will abut against the annular seat 131. Thus, it can avoid an internal friction of the motor 21, and the service life of the motor 21 will be increased.

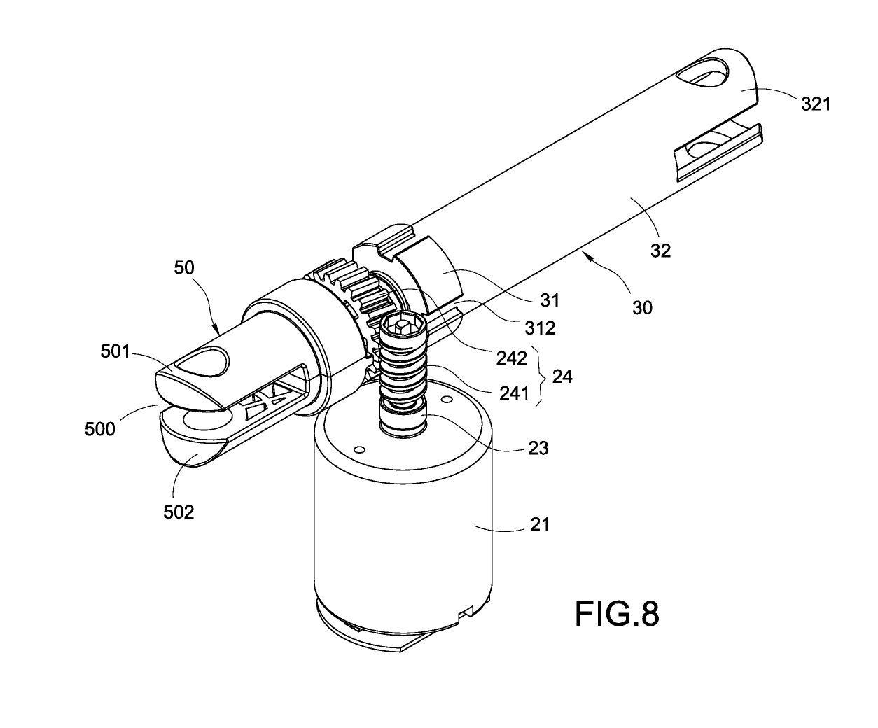

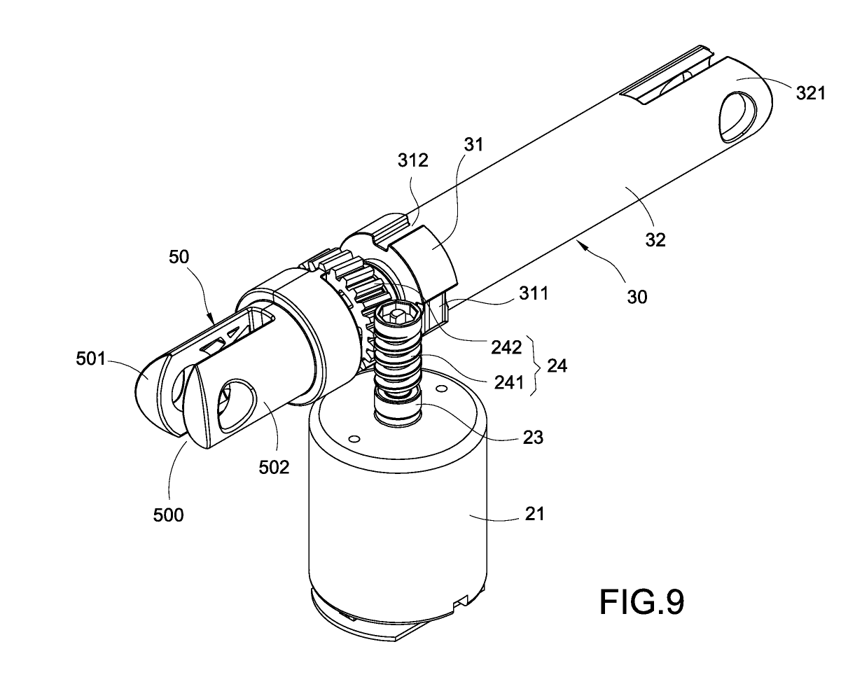

Please further refer to FIG. 8 and FIG. 9, they depict two setup angles of the rear stand after assembling. The rear stand 50 is composed of the first clamping piece 501 and the second clamping piece 502 which are coupled to form a trough 500. As shown in FIG. 8, when the first clamping piece 501 and the second clamping piece 502 are coupled in a way of up-down combination, the opening of the trough 500 is in a direction of horizontal (lateral). Also refer to FIG. 9, when the first clamping piece 501 and the second clamping piece 502 are coupled in a way of left-right combination, the opening of the trough 500 is in a direction of vertical (longitudinal).

Therefore, the opening direction (setup angle) of the rear stand 50 can be changed by adjusting an orientation of the combination of the first clamping piece 501 and the second clamping piece 502, and that will increase convenience of assembly.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A miniature linear actuator (1), including:
a shell (10) having a guiding rail (11) disposed on an inner wall; and
an actuator mechanism (20) disposed in the shell (10), and the actuator mechanism (20) including a motor (21) and a lead screw (22) driven by the motor (21);
a telescopic tube (30) including a nut (31) screwed with the lead screw (22) and an inner tube (32) integrally formed with the nut (31); the nut (31) having at least one switching structure (311) and at least one guiding slot (312) corresponding to the guiding rail (11); and
at least one limit switch (40) fixed in the shell (10); the limit switch (40) being capable of operating by a press of the switching structure (311).

2. The miniature linear actuator (1) according to claim 1, wherein the actuator mechanism (20) further includes a bearing (23); the motor (21) has a shaft (211), and the shell (10) is formed a supporting structure (13) corresponding to the shaft (211) on an inner wall thereof, and the bearing (23) is sleeved on the shaft (211) and stopped by the supporting structure (13) from moving.

3. The miniature linear actuator (1) according to claim 2, wherein the bearing (23) includes an inner bearing annular (231) and an outer bearing annular (232), and the supporting structure (13) includes an annular seat (131) and a blocking wall (132) protruding at an upper of the annular seat (131); the inner bearing annular (231) abuts against the shaft (211); one side of the outer bearing annular (232) abuts against the annular seat (131), and a perpendicular other side abuts against the blocking wall (132).

4. The miniature linear actuator (1) according to claim 2, wherein the actuator mechanism (20) further includes a worm gear group (24), and the worm gear group (24) includes a worm (241) and a worm gear (242) which are engaged with each other; the worm (241) is fixed at the shaft (211) of the motor (21), and the worm gear (242) is located at an end of the lead screw (22).

5. The miniature linear actuator (1) according to claim 4, further including a rear stand (50) and a fixing bearing (51); the rear stand (50) covers the fixing bearing (51), and the fixing bearing (51) is fixed on an end of the lead screw (22) through a screw (52).

6. The miniature linear actuator (1) according to claim 5, wherein the screw (52) is inserted in the lead screw (22) and extended to the location of the worm gear (50).

7. The miniature linear actuator (1) according to claim 5, wherein the rear stand (50) includes a first clamping piece (501) and a second clamping piece (502); the first clamping piece (501) and the second clamping piece (502) are coupled to form a trough (500), and the angle of the trough (500) can be changed by adjusting an orientation of a combination of the first clamping piece (501) and the second clamping piece (502).

8. The miniature linear actuator (1) according to claim 1, wherein the guiding slot (312) is formed on a peripheral surface of the nut (31).

9. The miniature linear actuator (1) according to claim 1, wherein the limit switch (40) is at least one fixing hole (41); the shell (10) has formed a plurality of pillars (12) on an inner wall thereof, and the at least one limit switch (40) is selectively positioned at one of the pillars (12).

10. The miniature linear actuator (1) according to claim 1, further including a front stand (321) configured in a fork shape, and the front stand (321) is integrally formed with the inner tube (32) at an outer end of the inner tube (32).
